(19) United States
(12) Patent Application Publication
(10) Pub. No.: US 2015/0338550 A1
(43) Pub. Date: Nov. 26, 2015

(54) METHOD AND SYSTEM FOR CHARACTERISING SUBSURFACE RESERVOIRS

(71) Applicant: STOCHASTIC SIMULATION LIMITED, Osborne Park, Western (AU)

(72) Inventor: Andrew Wadsley, Osborne Park (AU)

(73) Assignee: Stochastic Simulation Limited, Osborne Park (AU)

(21) Appl. No.: 14/646,322

(22) PCT Filed: Nov. 20, 2013
(86) PCT No.: PCT/AU2013/001334

§ 371 Date: May 20, 2015

(30) Foreign Application Priority Data
Nov. 20, 2012 (AU) 2012905042

(51) Int. Cl. G01V 99/00; G06F 17/10

(52) U.S. Cl. CPC G01V 99/005; G06F 17/10

(57) ABSTRACT

A computing apparatus (1000) for and method (100) of characterising a subsurface reservoir is disclosed. The method comprises: (i) receiving data representing a geological model of a reservoir (S1), the reservoir model comprising a plurality of grid-cells, where the reservoir model is divided into the said grid-cells, and a location or locations of one or more boreholes within the reservoir being modelled; (ii) receiving data representing a specification reservoir parameters for generating geological realisations of the modelled reservoir (S2); (iii) calculating the volume and pressure of each fluid phase in each grid-cell from the reservoir parameters a plurality of discrete time points, wherein a property of the grid-cells or the time points are not uniform amongst all the grid-cells (20); (iv) calculating the flux of each fluid phase between grid-cells and boreholes for each time point from the calculated volumes and pressures (S3); (v) calculating borehole production for each borehole from the calculated fluxes (36).

The present invention relates to a method and system for characterising subsurface reservoirs, and more particularly, determining the amount of fluids, the geological properties and the petroleum reserves of a subsurface reservoir using reservoir simulation.

### BACKGROUND

Fluids such as petroleum gases, petroleum liquids and brine are produced from subsurface reservoirs. Efficient and economic exploitation of these fluids requires quantification of the amount of fluids trapped in the reservoir, the amount of fluids which can be technically and economically produced over time, properties of the fluids, properties of the rocks which comprise the reservoir and properties of the geological formations in which the fluids are trapped. Fluids flow through the geological formations which comprise the reservoir and are produced from boreholes which intersect with the reservoir.

Geological models are generated to encapsulate the spatial distribution of rock and fluid properties which comprise the reservoir. These models typically comprise thousands of uniformly sized grid-cells each of which is tagged with spatially heterogeneous fluid and geological data sufficient to enable the calculation of the amount of the hydrocarbon vapour (gaseous phase), hydrocarbon liquid (oleic phase) and brine (aqueous phase) trapped in the reservoir at the location specified by the respective grid-cell.

Geological models are the input to reservoir simulators which use numerical algorithms to calculate the flow of fluids in the reservoir at uniform time intervals. These algorithms use physical parameters defined for each grid-cell to calculate the magnitude of the flow of fluids and the change of fluid and rock properties during the production of fluids from the reservoir. Parameters are defined for each grid-cell and typically include depth, spatial extent, total fluid volume, depth of fluid contacts, pressure, temperature, fluid properties such as compressibility, viscosity, saturation, density, capillary pressure and relative permeability, and rock properties such as porosity, permeability and compressibility.

These fluid and geological parameters are typically derived from laboratory measurements of properties of rock and fluid samples, from electrical, acoustic, mechanical, nuclear and other measuring devices placed in boreholes, from seismic and gravimetric data, from pressure and other sensors placed in pipelines and vessels containing the produced fluids, and from measurements of the amount of produced fluids through time.

The algorithms incorporated in reservoir simulators use the principles of mass and volume balance, and empirical relations such as fluid and rock equations-of-state and Darcy's Law (an equation that describes the flow of fluid through a porous medium), to calculate the flux of each fluid phase between grid-cells and between grid-cells and boreholes through time. A face of a cell refers to the connection between neighbouring cells through which the flow of fluids takes place. Typically a cell will have a plurality of neighbours with face connections between them.

The calculation of the flow of fluids is computationally expensive and typically requires the solution of large matrix equations with entries for the flux of the gaseous, oleic and aqueous phases for each cell and face for each simulated time period and the non-linear update of rock and fluid properties as a function of pressure and other parameters.

The calculation of fluid flow is made for a sequence of simulated time points. The time period between sequential time points is referred to as a time step.

History-matching refers to the modifying of fluid and geological parameters for each grid-cell in order to match the calculated amount of produced fluid through time with the historically measured production. Typically, history-matching is time-consuming as separate runs of the reservoir simulator need to be made for each modification to the grid-cell parameters repeatedly using the update sequence: 1) parameters in the geological model are modified; 2) this modified model is input to the reservoir simulator; and, 3) calculated fluid production for each well is then compared to the observed fluid production. The comparison between calculated and observed production is usually defined by a mismatch or error function which is a measure of the difference between the calculated and observed amounts for each of the produced gaseous, oleic and aqueous phases. This mismatch function is typically defined for the total production of the reservoir, for each well individually or for groups of wells.

Techniques have been developed to speed up the history-matching process including amongst others proxy modelling, inverse modelling and sensitivity coefficient generation, design of experiments (DoE) and response surfaces. Proxy modelling is typically based on a simplification of the geological model or numerical algorithm and provides an approximate solution to the history-match problem. Inverse modelling and sensitivity coefficient generation start with a base geological model and generate modifications to the current model which are likely to reduce the size of the mismatch function. DoE and response surface methodologies generate different realisations of a base geological model which typically span a range of a priori physically reasonable models. Each of these techniques requires the use of the reservoir simulator to recalculate fluid production and the mismatch function for the current geological realisation. The outcome of history-matching may lead to a preferred set of geological parameters but typically there is not a unique outcome to the history-matching problem.

A geological model is used as input to a reservoir simulator in order to forecast the production of petroleum gases and liquids and brine through time. Parameters in the model may have been history-matched but this need not be the case, particularly if there is no historical production at the time the geological modelling and reservoir simulation takes place. Petroleum reserves are the amounts of petroleum fluids that can be economically recovered from the reservoir and are usually estimated from a geological model and reservoir simulation. These estimates of petroleum reserves depend upon and are functions of the parameters of the geological model.

There is a plurality of combinations of reservoir parameters which can be modified leading to a concomitant plurality of reserves estimates calculated by the reservoir simulator. For example, if there are ten parameters each with ten value levels then the total number of combinations is ten billion (10¹⁰). As the number of parameters increases the number of combinations grows exponentially and it becomes infeasible to calculate the outcome of all combinations. DoE methodologies reduce the number of combinations required to span the space of geological realisations but typically the practical constraint on the number of solutions is the computational speed of the reservoir simulator. For small problems (<100,000 grid-cells) this can take minutes but for large models the time required to compute a solution typically takes hours to days on a high-performance computer cluster.

The present invention seeks to provide an improved method and system for characterising subsurface reservoirs.

In this specification the terms “comprising” or “comprises” are used inclusively and not exclusively or exhaustively.

Any references to documents that are made in this specification are not intended to be an admission that the information contained in those documents form part of the common general knowledge known to a person skilled in the field of the invention, unless explicitly stated as such.

### SUMMARY OF THE PRESENT INVENTION

According to an aspect of the present invention there is provided a method of characterising a subsurface reservoir, said method comprising:

(i) receiving data representing a geological model of a reservoir, the reservoir model comprising a plurality of grid-cells, where the reservoir model is divided into the said grid-cells, and a location or locations of one or more boreholes within the reservoir being modelled;
(ii) receiving data representing a specification of reservoir parameters for generating geological realisations of the modelled reservoir;
(iii) calculating the volume and pressure of each fluid phase in each grid-cell from the reservoir parameters at a plurality of discrete time points;
(iv) calculating the flux of each fluid phase between grid-cells and boreholes for each time point from the calculated volumes and pressures;
(v) calculating borehole production for each borehole from the calculated fluxes.

In an embodiment the method is characterised in that time steps between consecutive time points in respect of each grid-cell are not uniform to the grid-cells in the reservoir model.

In an embodiment the time step for each grid-cell is dependent on the identity of the grid-cell.

In an embodiment the method is characterised in that each grid-cell is not uniform in spatial dimension to all grid-cells in the reservoir model.

In an embodiment the method is characterised in that the pressure and fluid volume calculations for each grid-cell and between grid-cells and well boreholes are calculated at each time point use a stable explicit scheme that does not require the simultaneous solution of a large matrix system of linear equations for all grid-cells.

In an embodiment the fluid flux for each fluid phase between each grid cell uses a stable explicit method.

In an embodiment the mass balance for a plurality of grid cells at a time point in the stable explicit method includes a function of the previous potential of a phase.

In an embodiment the mass balance for a plurality of grid cells at a time point in the stable explicit method includes a product of an interpolation factor and a potential of a phase.

In an embodiment the mass balance for a plurality of grid cells at a time point in the stable explicit method is calculated from the three phase flux across a single face of the respective grid cell.

In an embodiment the mass balance for a plurality of grid cells at a time point in the stable explicit method is calculated simultaneously from the three phase flux across a plurality of faces of the respective grid cell.

In an embodiment the mass balance for a plurality of grid cells at a time point in the stable explicit method includes a function of the previous flux across a single face of the respective grid cell.

In an embodiment the mass balance for a plurality of grid cells at a time point in the stable explicit method includes a function of the previous flux across a plurality of faces of the respective grid cell.

In an embodiment data representing a geological model of a reservoir is derived from measurements of the reservoir.

In an embodiment specification reservoir parameters are derived from characteristics of the fluids in the reservoir and/or characteristics of the fluids produced by the reservoir.

In an embodiment each grid-cell is allocated to an equilibration region, an equation-of-state region and a saturation region.

In an embodiment for each fluid in the reservoir pressure and saturation in each grid-cell are calculated.

In an embodiment the density of the fluid in each grid-cell is calculated.

In an embodiment the capillary pressure in each grid-cell is calculated.

In an embodiment the method further comprises:

(vi) checking whether a termination condition is met;
(vii) calculating a perturbation of each of the reservoir parameters and repeating steps (iii) to (vii) when the termination condition is not met;
(viii) outputting the calculated production for each borehole.

In an embodiment steps (vi), (vii) and (viii) are performed in the simulator.

In an embodiment the method further comprises outputting the parameters of each grid-cell.

In an embodiment the parameter perturbations are calculated with an incremental perturbation point sampling technique.

In one embodiment the point sampling technique comprises a random point sequence.

In one embodiment the point sampling technique comprises a quasi-random point sequence.

In one embodiment perturbations are generated as trajectories or sequences of steps for each parameter.

In one embodiment when the perturbations are generated as trajectories, the trajectory sampling technique comprises a Lissajous curve technique.

In one embodiment when the perturbations are generated as trajectories, the trajectory sampling technique comprises a saw-tooth curve technique.

In an embodiment the parameter perturbations are calculated with an incremental perturbation path sampling technique.

In one embodiment the path sampling technique comprises a rapidly exploring dense tree technique.

In one embodiment the path sampling technique comprises a minimum spanning tree technique.

In one embodiment the path sampling technique comprises a random line segment technique.

In one embodiment the path sampling technique comprises a congruent lattice sampling technique.

In an embodiment the method further comprises receiving data representing historical fluid production and pressure data from each borehole and calculating a mismatch between historical and calculated fluid production and between historical and calculated pressure, before step (vi).

In an embodiment the calculated mismatch is used in step (vii) to calculate the perturbation of the of reservoir parameters.

In an embodiment the mismatch is calculated as the sum of the weighted differences between historical production and measured production for each fluid and between historical and measured pressure at a sequence of time points.

In an embodiment the mismatch is calculated as the sum of the weighted differences between historical fractional flow and calculated fraction flow at a sequence of time points.

In an embodiment the method further comprises receiving data representing measurements of seismic data and calculating a mismatch between historical and calculated seismic data, before step (vi).

In an embodiment the calculated mismatch is used in step (vii) to calculate the perturbation of the of reservoir parameters.

According to another aspect of the present invention there is provided a computing apparatus comprising one or more processors configured to perform the method defined above.

According to another aspect of the present invention there is provided a computer program comprising instructions for controlling one or more processors to perform the method defined above. In one embodiment the computer program is in a form stored on a non-transient computer readable medium.

According to another aspect of the present invention there is provided a computing apparatus comprising

(i) an input for receiving data representing a geological model of a reservoir, the reservoir model comprising a plurality of grid-cells, where the reservoir model is divided into the said grid-cells, and a location or locations of one or more boreholes within the reservoir being modelled;
(ii) an input for receiving data representing a specification of perturbations of reservoir parameters for generating geological realisations of the modelled reservoir;
(iii) a calculation module for calculating the volume and pressure of each fluid phase in each grid-cell from the reservoir parameters at a plurality of discrete time points;
(iv) a calculation module for calculating the flux of each fluid phase between grid-cells and boreholes for each time point from the calculated volumes and pressures; and
(v) a calculation module for calculating borehole production for each borehole from the calculated fluxes.

In an embodiment the calculation module for calculating the volume and pressure of each fluid phase in each grid-cell is configured to characterise each time point of each grid-cell as having a time step between consecutive time points where the time steps are not uniform among the grid-cells in the reservoir model.

In an embodiment the calculation module for calculating the volume and pressure of each fluid phase in each grid-cell is configured to characterise each grid-cell as being not uniform in spatial dimension among the grid-cells in the reservoir model.

In an embodiment the calculation module for calculating the flux of each fluid phase is configured to calculate the pressure and fluid volumes for each grid-cell and between grid-cells and well boreholes at each time point using a stable explicit scheme that does not require the simultaneous solution of a large matrix system of linear equations for all grid-cells.

In an embodiment the calculation module for calculating the flux of each fluid phase is configured to calculate volume and pressure of each grid cell for each of three phases using a three phase fluid flow calculation that uses a stable explicit method.

In an embodiment the apparatus further comprises:

(vi) a module for checking whether a termination condition is met;
(vii) a module for calculating a perturbation of the of reservoir parameters; and
(viii) a module for outputting the calculated production for each borehole.

In an embodiment the module for calculating perturbations is configured to generated perturbations as trajectories or sequences of steps for each parameter.

In an embodiment the apparatus further comprises a module for receiving data representing historical fluid production and pressure data from each borehole and calculating a mismatch between historical and calculated fluid production and between historical and calculated pressure.

According to another aspect of the present invention there is provided a computing apparatus comprising

(i) means for receiving data representing a geological model of a reservoir, the reservoir model comprising a plurality of grid-cells, where the reservoir model is divided into the said grid-cells, and a location or locations of one or more boreholes within the reservoir being modelled;
(ii) means for receiving data representing a specification of perturbations of reservoir parameters for generating geological realisations of the modelled reservoir;
(iii) means for calculating the volume and pressure of each fluid phase in each grid-cell from the reservoir parameters at a plurality of discrete time points;
(iv) means for calculating the flux of each fluid phase between grid-cells and boreholes for each time point from the calculated volumes and pressures; and
(v) means for calculating borehole production for each borehole from the calculated fluxes.

In an embodiment the means for calculating the volume and pressure of each fluid phase in each grid-cell is configured to characterise each time step between consecutive time points in respect of each grid-cell are not uniform the grid-cells in the reservoir model.

In an embodiment the means for calculating the volume and pressure of each fluid phase in each grid-cell is configured to characterise each grid-cell as being not uniform in spatial dimension to all grid-cells in the reservoir model.

In an embodiment the means for calculating the flux of each fluid phase is configured to calculate the pressure and fluid volumes for each grid-cell and between grid-cells and well boreholes at each time point use a stable explicit scheme that does not require the simultaneous solution of a large matrix system of linear equations for all grid-cells.

In an embodiment the means for calculating the flux of each fluid phase is configured to characterise calculate volume and pressure of a plurality of grid cells for each of three phases using a three phase fluid flow calculation that uses a stable explicit method.

In an embodiment the apparatus further comprises:

(vi) a means for checking whether a termination condition is met;
(vii) a means for calculating a perturbation of the of reservoir parameters; and
(viii) a means for outputting the calculated production for each borehole.

In an embodiment the means for calculating perturbations is configured to generated perturbations as trajectories or sequences of steps for each parameter.

In an embodiment the apparatus further comprises a means for receiving data representing historical fluid production and pressure data from each borehole and calculating a mismatch between historical and calculated fluid production and between historical and calculated pressure.

### DESCRIPTION OF DRAWINGS

Embodiments of the present invention will now be described, by way of example only, with reference to the accompanying drawings, in which:

FIG. 1 is a flow chart of an embodiment of a method according to an aspect of the present invention;

FIG. 2 is a flow chart showing an embodiment of a method of performing step S1 of FIG. 1;

FIG. 3 is a flow chart showing an embodiment of a method of performing step S2 of FIG. 1;

FIG. 4 is an example of defining the well index of a grid-cell;

FIG. 5 is an example of defining grid-cell-time steps;

FIG. 6 is an example of defining the ordering of grid-cell-time steps;

FIG. 7 is a flow chart showing an embodiment of a method of performing step S3 of FIG. 1;

FIG. 8 is an example of the flux directions between adjacent grid-cell-time steps;

FIG. 9 is an example of a rapidly exploring dense tree; and

FIG. 10 is a schematic block diagram of a computing apparatus according to an embodiment of the present invention.

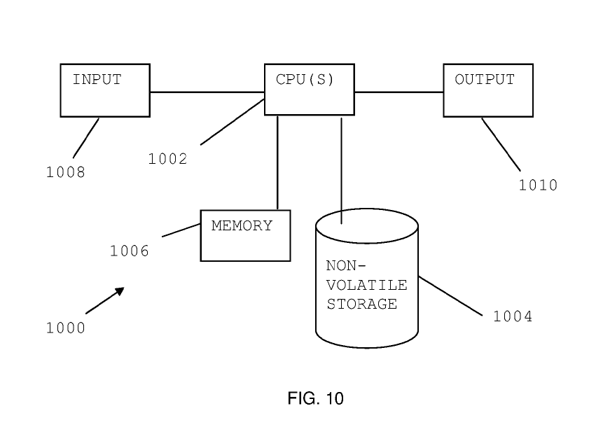

### DETAILED DESCRIPTION OF EMBODIMENTS OF THE INVENTION

The present invention integrates a method for solving the equations for fluid flow in a reservoir model with a method for generating a multiplicity of geological realisations of the reservoir and concomitant estimates of petroleum reserves. The invention is implemented by a suitably configured computing apparatus.

The reservoir model comprises a geological model of the reservoir being modelled and parameters specifying the nature of the fluid represented as being present in the reservoir. The fluid comprises petroleum (oil and gas) and brine. The geological model will have parameters for each grid-cell in the model, such as a discrete value of the permeability of the rock represented by each grid-cell and a size representation of the grid-cell. Parameters of the borehole may comprise for example the fractional flow rates and viscosities of fluid produced from each borehole. Parameters of the fluid may comprise for example the fractional pressures of fluids in each grid-cell. Other parameters may be included, but these example parameters allow for a model to be produced based on Darcy's Law of fluid flow in a porous medium, which for a single phase is:

$$Q = \frac{- kA}{μ} \frac{( {P}_{b} - {P}_{a} )}{L}$$

where Q is the total discharge, k is the permeability of the medium, A is the cross-sectional area, (P_{b}−Pₐ) is the pressure drop, μ is the viscosity and L is the length over which the pressure drop is taking place.

Darcy's Law is adapted for three dimensional interconnection of grid-cells for the three phases in a petroleum reservoir.

Whilst the geology of a reservoir generally does not change, the understanding of the geology and thus the representation of the geology of the reservoir in the model may change. Further the fluid present in the reservoir changes over time as it is produced from the reservoir, and the understanding of the fluid present in the reservoir at a given time may change, thus the representation of the fluid in the reservoir being modelled may change for a given time, but will also change over time to account for production. The understanding of the reservoir and/or the nature of the fluid present in the reservoir at a given time may change as a result of observations (that is measurements) taken over time. This is because the understanding is based on a “best fit” given the current information and uncertainty associated with a process of modelling a real object in a practical manner. As more information is accumulated this fitting process can accommodate this new information. In other words the refinement of the model over time is constrained by progressive accumulation of production history over time.

The present invention is embodied in a method of characterising subsurface reservoirs performed by a purpose configured computing apparatus, such as a computer 1000 (or a plurality of computers) controlled by a computer program. The computer program comprises a plurality of computer executable instructions for controlling one or more processors 1002 of the one or more computers to perform the method. The computer program is stored on a non-transient computer readable medium 1004 (such as a hard disk drive, flash memory, CD, DVD etc.) and able to be uploaded to memory 1006 of the computer(s) for execution. Each step in the method may be performed by a computing module configured to perform one or more of the respective steps described below. Each computing module may take the form of a computer programmed with a subroutine or self-contained executable file. Each module may be executed on a single processor or a plurality of processors, where typically a subset of the time point calculations for those grid-cells having the same time steps is processed on each processor. A processor may be a notional processing unit, a physical processor or a logical processor. Each perturbation iteration can be implemented sequentially using a single processor or a plurality of processors or perturbation iterations can be implemented across a plurality of processors which calculate the results of each perturbation iteration in parallel.

The processor(s) 1002 are able to receive an external input from input device 1008, which may be for example an I/O device, or a computer network. Such an input may be data for storage on the storage medium 1004 or user input.

The processor(s) 1002 are able to provide an output from output device 1010, which may be for example an I/O device, or a computer network or a display. Such an output may be data for storage an external storage medium (eg. CDROM/DVD/flash memory device, hard disk drive) or data for output to another apparatus, or for display to a user.

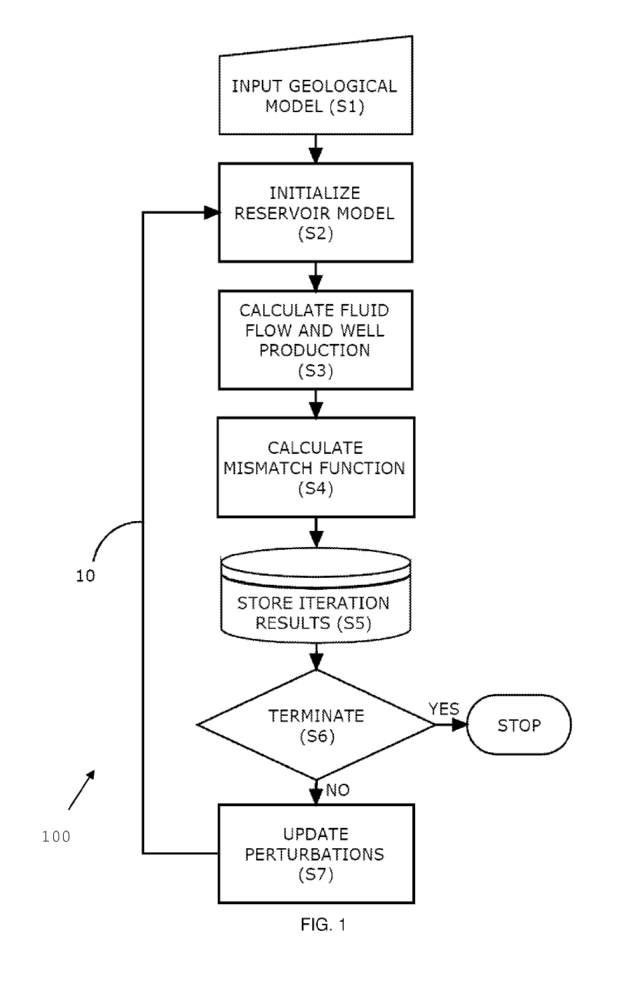

Referring to FIG. 1, there is shown a method 100 of characterising subsurface reservoirs according to an embodiment of the present invention. The method uses a geological model and other parameters to generate a reservoir model and then uses the reservoir model to simulate production from the reservoir over a given time period.

The method 100 commences with step S1, which in general terms is inputting a geological model in digital format. The input will typically take the form of uploading a data file containing a representation of the geological model in a standard format.

The method 100 then proceeds to the next step S2, which is the top level of perturbation iteration 10. Step S2 initializes grid-cell data in the reservoir model. In an embodiment the grid-cells sizes change according to the respective position of the grid-cell in the reservoir model. In an embodiment the grid-cells are spatially coarsened with distance from each borehole.

To determine the initial grid-cell data, a number of calculations are performed. Each grid-cell belongs to one and only one equilibration region. The depths of the gas-oil and oil-water contacts are specified for equilibration regions in the reservoir. For each fluid in the reservoir pressure and saturation (ratio of volume of fluid to volume of pores) in each grid-cell are calculated from the pressure at the oil-water contact, alternatively from the pressure at the gas-oil contact. The density of the fluid in each grid-cell and the capillary pressure of the fluid in each grid-cell are calculated. The density of the fluid is implicitly calculated from an equation-of-state (EOS) for each fluid. An equation-of-state is assigned to EOS regions in the reservoir and each grid-cell belongs to only and only one EOS region. A capillary pressure relation for each fluid is assigned to saturation regions in the reservoir and each grid-cell belongs to only and only one saturation region.

The method 100 then proceeds to the next step S3, which calculates fluid flow between grid-cells and well boreholes in time steps over a period of time. In an embodiment the three phase fluid flow calculated uses a stable explicit method. In an embodiment the time step of each grid-cell changes according to positioning of the grid-cell in the reservoir model. In an embodiment the time steps are increased with the distance of grid-cells from each borehole. In an embodiment the time steps are increased proportional to the change in pressure at the location of the grid-cell in the reservoir model. In an embodiment the stable explicit method is a modified Saul'yev method. In an embodiment the mass balance for a cell at a time-point in the stable explicit method includes a function of the previous potential of a phase. In an embodiment the mass balance for a cell at a time-point in the stable explicit method includes a product of an interpolation factor and a potential of a phase. In an embodiment the mass balance for a cell at a time point in the stable explicit method is calculated from the three phase flux across a single face of the cell. In an embodiment the mass balance for a cell at a time point in the stable explicit method is calculated simultaneously from the three phase flux across a plurality of faces of the cell. In an embodiment the mass balance for a cell at a time point in the stable explicit method includes a function of the previous flux across a single face of the cell. In an embodiment the mass balance for a cell at a time point in the stable explicit method includes a function of the previous flux across a plurality of faces of the cell.

The calculated fluid flow into boreholes is a calculated fluid production from the reservoir for a given time step.

In one embodiment the pressure and fluid saturations for each grid-cell-time point and between grid-cells and well boreholes are calculated at each time point using a stable explicit scheme which does not require the simultaneous solution of a large matrix system of linear equations for all grid-cells. A list of grid-cell-time steps gives the order in which the pressure and phase volumes for grid-cell-time steps are updated. In one embodiment this order is calculated from the location of the grid-cell and the sequence of simulation time points. The stable explicit scheme implicitly calculates the pressure and saturation of each phase in each grid-cell in the order in which the grid-cell time steps are given in the list. In the preferred embodiment a set of matrix equations are generated for a sub-set of grid-cell-time steps in the list and these equations are solved using an iterative non-linear solution technique and a linear matrix solver for each such sub-set. Fluid flux between spatially adjacent grid-cell-time steps is calculated implicitly using the multi-phase form of Darcy's Law with fluid and rock properties calculated from fluid and rock equations-of-state associated with the EOS region assigned to the grid-cell, relative permeability and capillary pressure relations associated with the saturation region assigned to each grid-cell, the depth of each grid-cell and the transmissibility assigned to the interface between the grid-cells. The fluid and rock equations-of-state, the relative permeability and capillary pressure relations, grid-cell depth and transmissibility may have been perturbed during the course of the solution.

In the preferred embodiment each segment of a borehole is implemented as a virtual node which assigns pressure and fluid volumes to each segment. Algorithmically, these segments are treated in the same manner as grid-cells with segment-time steps corresponding to grid-cell-time steps. The difference between the total fluid flux into and out of a segment-time step is the fluid production assigned to the segment over the corresponding time-step. Fluid production for each segment is summed to give fluid production for the associated well over the time-step.

The next step in an embodiment of the method 100 is S4, which calculates a mismatch function between calculated fluid production and measured fluid production for a given time step.

The mismatch function is calculated as the sum of the weighted differences between production and measured production for each fluid at a sequence of time points. This sum may be taken for example over time points for single wells or over a group of wells. The difference in fluid production may relate to the difference between the actual fluid rates such as gas rate, oil rate or water rate; alternatively, to the difference between ratios of fluid rates such as gas-oil ratio, gas-water ratio or water-cut; alternatively, to more complex functions of fluid production such as reservoir fractional flow or other combinations of production rates and cumulative fluid production; alternatively, to the difference between reservoir fluid recovery and recovery from analogue reservoirs; alternatively, to the difference between measured borehole pressure and calculated pressure.

The method 100 then proceeds to the next step S5, which is to output the results of the current perturbation iteration or to store these results on a computer storage device.

In an embodiment the stored results are for each iteration 10:
i) fluid production for groups of wells,
ii) the mismatch function,
iii) the amount of remaining fluid by reservoir region,
iv) the current parameter values,
v) fluid reserves, and optionally
vi) pressure and fluid saturation amongst other properties for groups of grid-cells, and optionally
vii) calculated seismic properties, e.g. impedance, for groups of grid-cells.

In an embodiment the data stored, for each iteration 10 are: the values of the current perturbations assigned by step S2 for the first iteration and for subsequent iterations by step S7, fluid production for each time step and for each borehole calculated in step S3, and the value of the total mismatch function and the individual mismatch functions calculated in step S4. Depending on the model controls input in step 14, step S5 stores to a computer storage device sufficient data from computer memory to save the state of the program for possible restart of the program and restart of iteration 10.

The next step in the method 100 is S6, which determines whether the perturbation iteration 10 should terminate by testing whether one or more criteria are met. In the event that the iteration 10 is terminated (STOP) the method 100 ends.

Termination of the perturbations occurs when one of the following conditions for example is met:
i) the maximum number of iterations has been reached,
ii) the maximum allocated computer time has been reached,
iii) convergence to a best estimate of petroleum reserves,
iv) convergence to a best history-match, or
v) some other termination condition has been satisfied.

In the event that the iteration 10 is not terminated, the next step in the method is S7, which calculates parameter perturbations to be applied for the next iteration 10.

In an embodiment the parameter perturbations are calculated with an incremental perturbation random exploring path sampling technique. In one embodiment the path sampling technique comprises a rapidly exploring dense tree technique.

In one embodiment perturbations are generated as trajectories or sequences of steps for each parameter. In one embodiment the magnitude of these steps for each parameter is defined by a periodic function with ordinate the index of the current perturbation iteration. Such periodic functions may include trigonometric and triangular waveforms, eg. Lissajous or sawtooth functions. In this method the perturbation of each parameter is independent of the perturbations of the other parameters. Another embodiment incorporates a method of generating perturbations by selecting the magnitude of the perturbations from a multivariate probability distribution. In this case the magnitude of the parameter perturbations may be correlated. Another embodiment defines a quasi-random sequence of sampling points such as a Sobol or Halton sequence in the multidimensional space of parameter values. These sample points are connected by a directed graph such as a minimum spanning tree or rapidly exploring dense tree. Each edge of the graph defines a parameter perturbation. The perturbation is the change in parameter value from the start to the end point of the edge. Another embodiment uses a congruent lattice sampling algorithm. Another embodiment uses a Markov chain Monte Carlo algorithm to generate perturbations which depend on the change in mismatch function over the previous perturbation iteration. Perturbations are defined for equilibration, EOS, saturation, fluid-in-place and other regions specified by combinations of geological strata, coordinate boxes, polygonal areas, fault blocks and interpolators such as kriging or Gaussian sequential simulation.

Thus the first perturbation iteration 10 comprises steps S2, S3, S4, S5 and S6. If the termination condition of S6 is satisfied then the computer program terminates. Otherwise, subsequent perturbation iterations 10 comprise steps S7, S2, S3, S4, S5 and S6.

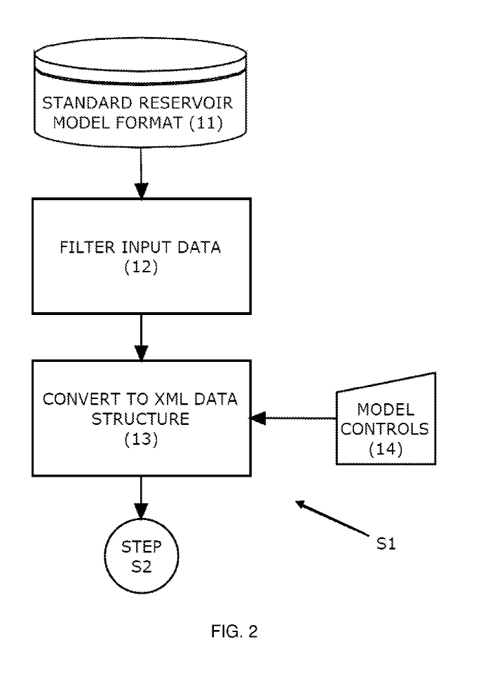

With reference to FIG. 2, step S1 of the method 100 of the present invention will now be described in more detail. Initially the method of step S1 inputs data that has been provided in a format suitable for reservoir simulation from a computer storage device 11. An industry standard reservoir simulation format comprises of a sequence of keywords and data forming a script that provides instructions to the reservoir simulator on how to carry out the simulation. A data filter 12 reads this script and, using a data analysis filter, extracts those data items and instructions which specify the algorithms necessary for the calculation of fluid and rock properties. Such data and instructions include grid-cell parameters and properties, controls on the maximum time-step and period of time to be simulated and controls on the options to be used in calculating fluid and rock properties. There may also be a selection of possible options, such as how the EOS operates or how the equilibration is carried out. Converter 13 converts the extracted data and instructions into an XML data structure which is stored in computer memory, or on a computer storage device for use in step S2. Additional controls on the model including the specifications on how the model behaves are received at input 14 and are combined with the stored XML data structure for use in step S2. The specifications include specifications of equilibration between phase pressures in a grid-cell and between grid cells, EOS (which provides that the phases are in thermodynamic equilibrium), saturation (of each phase in a given volume), fluid-in-place, cell-face and combination regions.

Regions are defined by an index assigned to each grid-cell. Associated with each index is a relation consisting of data and instructions which specify which algorithms are invoked during the course of the simulation. In the preferred embodiment equation of state algorithms are provided to calculate fluid properties:
for grid-cells containing brine only;
for grid-cells containing brine and under-saturated oleic phase;
for grid-cells containing brine and a gaseous phase; and
for grid-cells containing brine, an oleic phase and a gaseous phase.

In the preferred embodiment algorithms are provided to calculate fluid relative permeability using:
Corey exponents;
LET parameters;
Tables of relative permeability indexed by water, oil and gas saturation; and/or
Three-phase relative permeability using the Stone I or the Eclipse formulation.

In the preferred embodiment algorithms are provided to calculate gas-oil and oil-water capillary pressure using:
Brooks-Corey indices;
LET parameters;
Tables of capillary pressure indexed by water and gas saturation; and/or
Pseudo-capillary pressure calculated from vertical extent of each grid-cell.

In the preferred embodiment the following data items, in addition to perturbation parameters, are specified from the input data for each index for each type of region underlined below:

equilibration
depth of oil-water contact, depth of gas-oil contact, pressure at oil-water contact alternatively pressure at gas-oil contact, fluid saturation pressure as a function of depth alternatively fluid composition as a function of depth;

### EOS

water formation volume factor, water viscosity, water compressibility, water density, oil formation volume factor, oil viscosity, oil compressibility, oil density, gas formation volume factor, gas viscosity, gas density, rock compressibility;
   saturation
immobile water saturation, residual water saturation, residual oil saturation to water, residual oil saturation to gas, residual gas saturation, critical gas saturation, maximum water relative permeability, water relative permeability at residual oil saturation, oil relative permeability at residual water saturation, oil relative permeability at residual gas saturation, gas relative permeability at residual water saturation, gas relative permeability at residual oil saturation, minimum oil saturation, Stone I beta exponent, and as alternatives i) Corey relative permeability, ii) LET relative permeability, iii) saturation table relative permeability, with respective data values i) Corey exponents for water, oil-water, gas and oil-gas, and Brooks-Corey lithology and entry pressure indices, ii) L, E and T coefficients for water, oil-water, gas, and oil-gas, and L, E, T coefficients for water-oil and gas-oil capillary pressure, iii) tabular expressions of water and oil relative permeability as a function of water saturation, gas and oil relative permeability as a function of gas saturation, water-oil capillary pressure as a function of water saturation and gas-oil capillary pressure as a function of gas saturation;
   fluid-in-place
fluid scale factor;
   cell-face
transmissibility factor, gouge zone permeability, thickness and area.

These data items are real world measurements or derivations on those measurements or have been perturbed to match production measurements.

Combination regions are defined by boolean operations on any set of previously defined regions in addition to regions specified by:
i) geological strata indexed by model layer where the region index is assigned if the layer associated with the grid-cell lies within a the given geological stratum,
ii) coordinate boxes which are specified by three pairs of Cartesian coordinate indices which for each index pair give the minimum and maximum coordinate index where the region index is assigned if the three-dimensional coordinate index of the grid-cell lies within the box,
iii) polygonal areas which are specified by a closed polygon where the region index is assigned if the world coordinates of the centre of the grid-cell lies inside alternatively outside the polygon,
iv) radial area where the region index is assigned if the world coordinates of the centre of the grid-cell lies inside, or alternatively outside, the circular area defined by the centre of a circle and given radius,
iv) polygonal traces where the region index is assigned if the line joining the world coordinates of the centre of two adjacent grid-cells intersects the polygonal trace,
v) fault blocks where the region index is assigned if the grid-cell lies inside the fault block.

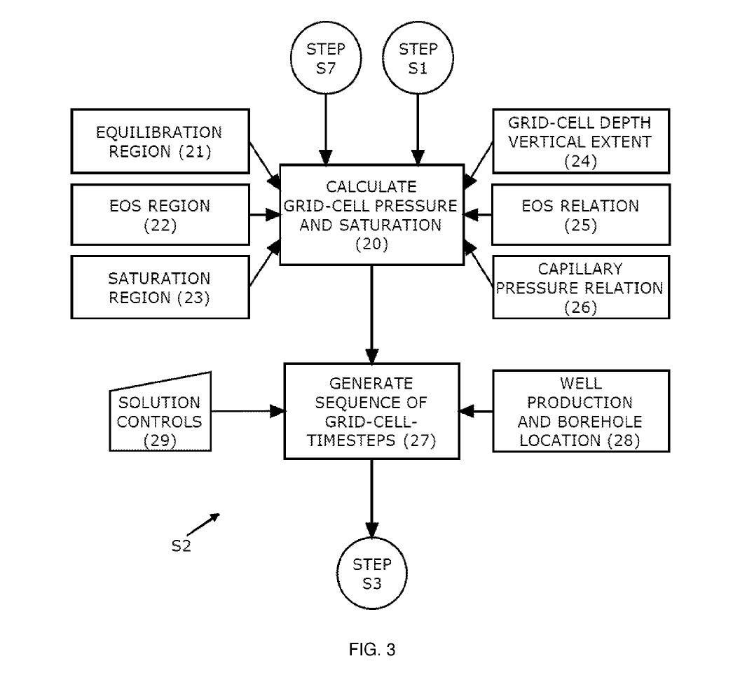

Referring to FIG. 3, step S2 uses the common data structure passed from step S1 in the case of the first perturbation iteration, alternatively step S7 in the case of the second and subsequent perturbation iterations, stored in computer memory, to initialise the reservoir simulation model. This data structure is augmented by other data structures necessary for the proper operation of the computer program (such as tolerances to control convergence of calculations and maximum allowable pressure changes in a grid-cell). A reservoir simulation model is initialised using step 20 which calculates at time zero, the start of the simulation period, the pressure and saturation of each fluid phase collocated to the centre of each grid-cell.

Each grid-cell is a member of an equilibration region for which pressure and depth at the oil-water contact, alternatively the gas-oil contact, are specified to be in equilibrium. The pressure p for each grid-cell is calculated by sub step 21 as follows:

$$p = \{ \begin{matrix}{{p}^{⋒}}_{g} - {\tilde{P}}_{cg} & for {z}_{c} < {z}_{goc} \\ {{p}^{⋒}}_{o} & for {z}_{goc} \leq {z}_{c} \leq {z}_{owc} \\ {{p}^{⋒}}_{w} + {\tilde{P}}_{cw} & for {z}_{owc} < {z}_{c}\end{matrix}$$

where \tilde{P}_{cg} and \tilde{P}_{cw} are gas and water capillary pressure, respectively, and phase pressure \hat{p}_{α} for each phase α=gas, oil and water are calculated by solving the non-linear equation \hat{p}_{α}(z_{c})−γ_{α}(\hat{p}_{α})z_{c}=ψ₀ for each phase, where z_{c} is the depth of the grid-cell, ψ₀ is the pressure at the oil-water contact z_{owc} alternatively the gas-oil contact z_{goc} specified for the equilibration region and γ_{α}(\hat{p}_{α}) is the phase density calculated from the equation of state.

Each grid-cell is also a member of an EOS region for which fluid density is specified as a function of fluid composition and pressure.

Each grid-cell is also a member of a saturation region defined in sub-step 23 which specifies which capillary-pressure relation recorded in sub-step 26 is used in the initialisation step 20.

In one embodiment the capillary pressure relation is modified using pseudo-capillary pressure to ensure equilibrium between fluid pressure, saturation and capillary pressure over the vertical extent of the grid-cell. The depth of the oil-water contact and the gas-oil contact, the pressure at the oil-water contact and at the gas-oil contact, the equation-of-state relation, the capillary pressure relation, the depth and the vertical extent of the each grid-cell may have been perturbed during the solution.

Well production and borehole location data 28 are specified in the input reservoir model in storage 11. This data together with additional solution controls 29 are used to generate a sequence of grid-cell-time steps using step 27.

Each time-point in the sequence is separated by a grid-cell-time step where the definition of grid-cell-time point includes time-points for grid-cells and for segments of a well borehole. The time-steps of spatially adjacent grid-cells need not be the same and time-points do not need to be equally spaced in time. The grid-cell-time steps are placed in an ordered list.

In the preferred embodiment the sequence of grid-cell-time steps is generated by step 27 in three steps:

### Firstly,

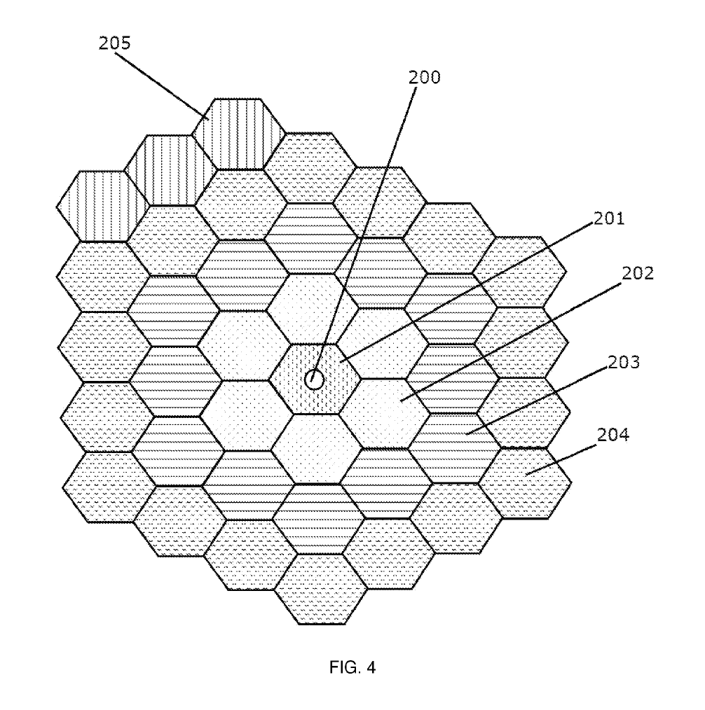

grid-cells are given a well index which is a measure of their adjacency distance from the nearest well borehole. By way of example, FIG. 4 shows a plan view of a set of grid-cells which form part of a simulation model. In this example the grid-cells are hexagonal in shape with a well borehole intersecting the grid-cells at 200. The grid-cell 201 is given a well index of 1; grid-cell 202 adjacent to 201 is given a well index of 2; grid-cell 203 adjacent to 202 is given a well index of 3; in this manner grid-cells 204 and 205 are respectively given well indices of 4 and 5.

### Secondly,

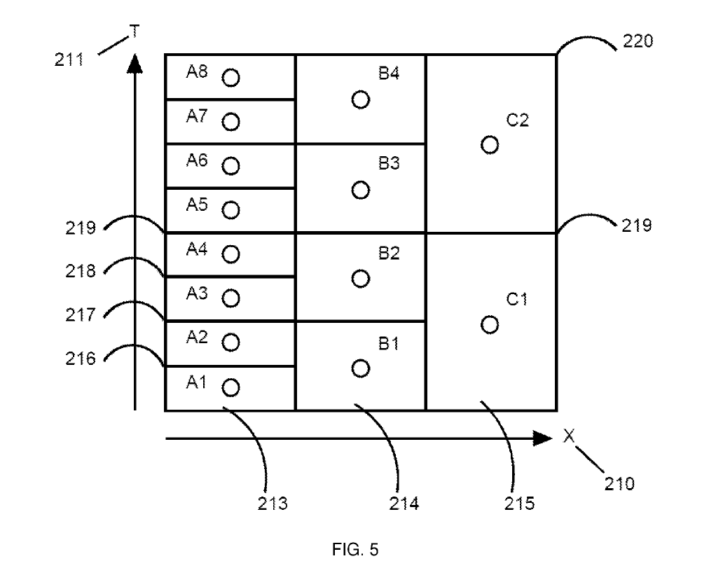

a number of time-points are assigned to each grid-cell as a function of their well index and pore-volume, the total time period to be simulated, and the maximum time-step size assigned to the grid-cell intersected by the well borehole. In the preferred embodiment the number of time-points assigned to adjacent grid-cells do not differ by more than a factor of two. By way of example, FIG. 5 shows a schematic view of three grid-cells which have been assigned time-points. The axis 210 represents a spatial coordinate and axis 211 represents the temporal coordinate axis in this schematic diagram. Grid-cell 213 has been assigned eight time-points the first four of which are 216, 217, 218 and 219; the corresponding grid-cell-time steps are A1, A2, A3 and A4; the remaining four grid-cell-time steps are A5, A6, A7 and A8. Grid-cell 214 has been assigned four time-points the first two of which are 217 and 219; the corresponding grid-cell-time steps are B1 and B2; the remaining two grid-cell-time steps are B3 and B4. Grid-cell 215 has been assigned two time-points which are 219 and 220; the corresponding grid-cell-time steps are C1 and C2.

### Thirdly,

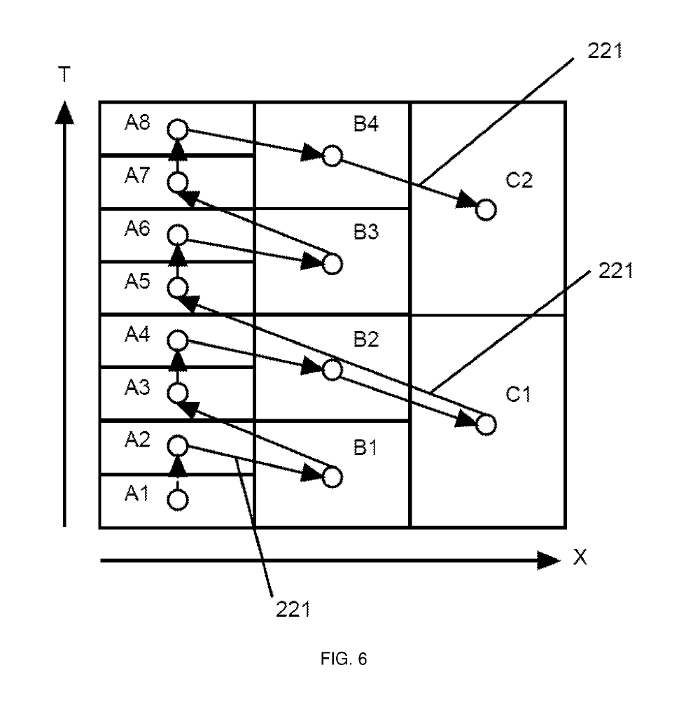

grid-cell-time steps are diagonally ordered on increasing time-point and well index. The resulting ordering for the example given in FIG. 5 is shown in FIG. 6 where the ordering is given by the directed graph 221 starting at A1 and linking sequentially A1, A2, B1, A3, A4, B2, C1, A5, A6, B3, A7, A8, B4 and C2.

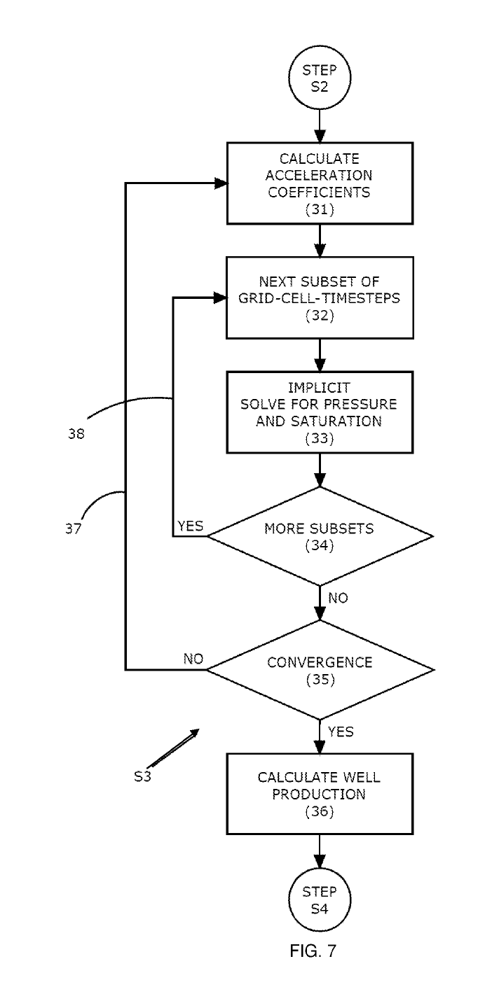

Referring to FIG. 7, step S3 of the present invention takes data from step S2 stored in computer memory 1006 and uses step 31 to acceleration the convergence of the calculation of pressure and fluid saturation for each grid-cell-time point. In the preferred embodiment step 31 uses a non-linear GMRES algorithm (Hans de Sterck, Steepest descent preconditioning for nonlinear GMRES optimization, Numer. Linear Algebra Appln. (2012)).

Step 31 is the top level of an iteration 37 which terminates at step 35 if a termination condition has been satisfied. The preferred embodiment terminates when the maximum change in pressure over all grid-cell-time steps is sufficiently small, for example <0.1 psi.

Step 32 selects a subset of grid-cell-time steps from the sequence given by step 27. In the preferred embodiment this subset is a column of grid-cells each with the same spatial coordinate indices and each with the same time-point. Step 32 is the top level of a loop 38 over all grid-cell-time steps which terminates at step 34 if all grid-cell-time steps have been updated.

Fluid flux into and out of a grid-cell-time step is calculated at step 33 using the multi-phase form of Darcy's Law between spatially and temporally adjacent grid-cell-time steps.

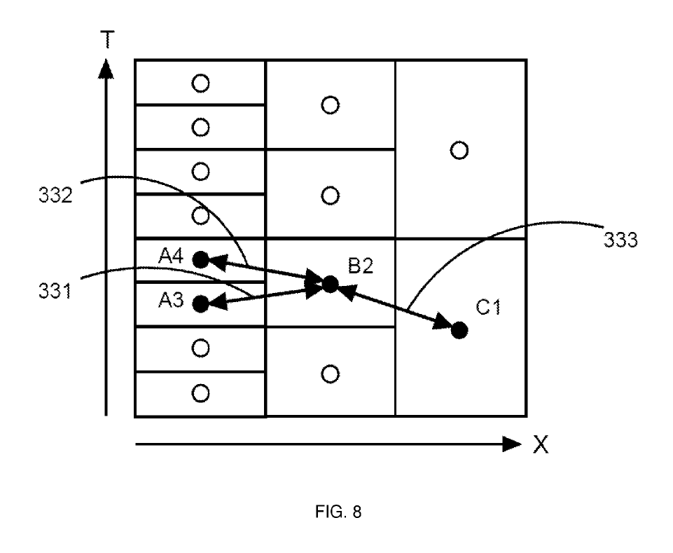

Referring to FIG. 8, an example is given of the flux 331, 332, and 333 to be calculated between grid-cell-time step B2 and adjacent grid-cell-time steps A3, A4 and C1, respectively.

In an embodiment step 33 calculates these fluxes for each grid-cell-time point using a modified form of the stable explicit method of Saul'yev (V. K. Saul'yev, Integration of Equations of Parabolic Type by the Method of Nets, Transl G. J. Tee, Editor K. L. Stewart, Pergamon Press Oxford, 1964).

In the preferred embodiment adjacent grid-cell-time steps which precede the current subset are referred to as upper cells and adjacent grid-cell-time steps which come after the current subset are referred to as lower cells.

Referring to FIG. 6, grid-cell-time steps A3 and A4 precede B2 and C1 comes after B2 in the sequence. A3 and A4 are referred to as upper cells and C1 is referred to as a lower cell with respect to B2.

In an embodiment the mass balance for a cell at a time-point includes a function of the previous potential of a phase (ψ_{α}^{t} in the equation below).

In an embodiment the mass balance for a cell at a time-point includes a product of an interpolation factor and a potential of a phase (ζ0 in the equation below).

For a grid-cell-time step within the subset, referred to as the current cell, adjacent cells within the subset are referred to as implicit cells. The solution of the pressure and fluid saturation equations solves for volume balance and mass balance for each hydrocarbon component in the current cell. The mass balance of a component n^{k} at the k^{th} time-point is given by the equation:

$${n}^{k} = {n}^{k - 1} + {\sum }_{α , i} {T}_{i} {Λ}_{α i}^{k} ( {ψ}_{α i}^{k} - {ψ}_{α}^{k} ) + {\sum }_{α , u} {T}_{u} {Λ}_{α u}^{k} ( {ψ}_{α u}^{k} - ( 1 - ζ ) {ψ}_{α}^{k} + {ζψ}_{α}^{t} ) + {\sum }_{α , l} {T}_{l} {Λ}_{α i}^{k} ( {ψ}_{α l}^{k} - ( {ζψ}_{α}^{k} + ( 1 - ζ ) {ψ}_{α}^{t} ) )$$

where n^{k-1} is the mass of the component at the preceding time-point; the sum Σ_{α,i} is over all fluid phases and a single adjacent cell indexed by i, alternatively over a plurality of adjacent cells, Tᵢ is the transmissibility between the current cell and i, Λ_{αi}^{k} is the upstream total mobility of the component in phase α implicitly evaluated at the k^{th} time-point between the cell and i, ψ_{αi}^{k} is the potential of phase α in i and ψ_{α}^{k} is the potential of phase α in the current cell; the sum Σ_{α,u} is over all fluid phases and adjacent upper cells indexed by u, Tᵤ is the transmissibility between the current cell and u, Λ_{αu}^{k} is the upstream total mobility of the component in phase α evaluated at the current time-point between the current cell and u, and ψ_{αu}^{k} is the potential of phase α in u and ψ_{α}^{t} is the potential of phase α in the cell evaluated at the previous iteration 37; the sum Σ_{α,i} is over all fluid phases and adjacent lower cells indexed by l, Tₗ is the transmissibility between the current cell and l, Λ_{αl}^{k} is the upstream total mobility of the component in phase α implicitly evaluated at the current time-point between the cell and l, and ψ_{αl}^{t} is the potential of phase α in l; and ζ is an interpolation factor which lies in the range 0≦ζ≦1.

The interpolation factor ζ extends the original method of Saul'yev which corresponds to a value of _{—}ζ=0. A value of _{—}ζ=1 preserves mass balance which is not preserved in the Saul'yev method. In the original Saul'yev method the phase potential ψ_{α}^{t} is the value of the potential at the start of the time step. In this formulation, the equation is used iteratively to calculate the phase potential ψ_{α}^{k} at the end of the time step and ψ_{α}^{t} is the value of the potential at the start of each iteration.

Following termination of the iteration loop 37, step 36 calculates fluid production for each well and fluid reserves, and the results are stored in computer memory and passed to step S4.

Step S4 of an embodiment of the present invention calculates the mismatch function for each perturbation iteration 10.

An example well-mismatch function is given by:

$$\frac{1}{2} {\sum }_{c , w , k} {{w}_{cw}^{k} ( {Q}_{cw}^{k} - {\overline{Q}}_{cw}^{k} )}^{2}$$

where the sum is taken over all components c, wells w and time steps k, w_{cw}^{k} is a weighting factor and Q_{cw}^{k} and Q̅_{cw}^{k} are the observed and calculated well production over the time step, respectively.

In the preferred embodiment the mismatch function is calculated as a weighted sum of oil-rate, gas-rate, water-rate, water-cut alternatively oil-cut, gas-oil-ratio alternatively gas-liquid ratio, well-pressure, region-pressure, and fractional-flow functions calculated over a sequence of time-points for a plurality of wells and for a plurality of regions. More specifically these are:

oil-rate
the weighted squared difference between calculated and observed oil production rate;
   gas-rate
the weighted squared difference between calculated and observed gas production rate;
   water-rate
the weighted squared difference between calculated and observed water production rate;
   water-cut
the weighted squared difference between calculated and observed water-cut, alternatively oil-cut;
   gas-oil-ratio
the weighted squared difference between calculated and observed gas-oil ratio, alternatively gas-liquid ratio;
   well-pressure
the weighted squared difference between calculated and observed well-head pressure, alternatively borehole pressure;
   region-pressure
the weighted squared difference between calculated and observed average region pressure;
   fractional-flow
the weighted squared difference between calculated and observed fractional flow using the method of Dake (Dake, L. P., The Practice of Reservoir Engineering, Developments in Petroleum Science, 36, Elsevier Science Publishing Company, Amsterdam (1994)).

Step S7 is described in more detail. Step S7 updates parameter perturbations. Perturbation parameters for regions are specified for each type of region stored in step 14 as described above. In a preferred embodiment this functionality is extended by adding perturbations as follows:

pore-volume
factors which perturb the pore-volume of a grid-cell;
   permeability
factors which perturb transmissibility between adjacent grid-cells;
   vertical-permeability
factors which perturb transmissibility in the vertical direction between adjacent grid-cells;
   anisotropy
factors which perturb directional transmissibility between grid-cells;
   depth
factors which perturb the centre depth of a grid-cell;
   vertical-extent
factors which perturb the vertical extent of a grid-cell;
   shape
factors which modify the shape factor for dual-porosity systems;
   aquifer
factors which modify the parameters of an aquifer influence function;
   distance
factors which scale transmissibility as a function of distance from a polygonal trace;
   deformation
factors which use the technique of gradual deformation between a plurality of Gaussian random surfaces so as to perturb a parameter;
   kriging
factors which use kriging to interpolate between a plurality of pilot points so as to perturb a parameter (Michel David, Geostatistical Ore Reserve Estimation, Elsevier Scientific Publishing Company, Amsterdam, 1977);
   surface
factors which use interpolation between a plurality of surfaces so as to perturb a parameter;
   borehole
factors which perturb the connection relation between boreholes and grid-cells;
   tubing
factors which perturb the friction factor and choke coefficient of tubing in boreholes.

Each perturbation is assigned a range by specifying a minimum and maximum value, each perturbation can be applied either additively or multiplicatively, each parameter can be optionally logarithmically transformed before applying a perturbation, and each factor is assigned a maximum step-size before being applied.

In a preferred embodiment perturbations are generated by a combination of

distribution
perturbations are selected from a probability distribution being one of: uniform, triangular, bi-triangular, normal, lognormal, beta and exponential, each distribution being defined by mean and variance; alternatively a discrete cumulative probability density defined by a table of parameters;
   trajectory
perturbations are selected from a periodic function with ordinate indexed by perturbation iteration number with a specified waveform being one of sine-wave or triangular-wave and assigned an amplitude, being the maximum step-size, and frequency and phase parameters;
   sampling
perturbations are selected from a directed graph, the nodes of which have been generated using a low-discrepancy Sobol sequence and connected by rapidly exploring dense tree algorithm (Sobol', I. M., Global sensitivity indices for nonlinear mathematical models and their Monte Carlo estimates, Mathematics and Computers in Simulation, Elsevier, 55 (2001) 271-280).

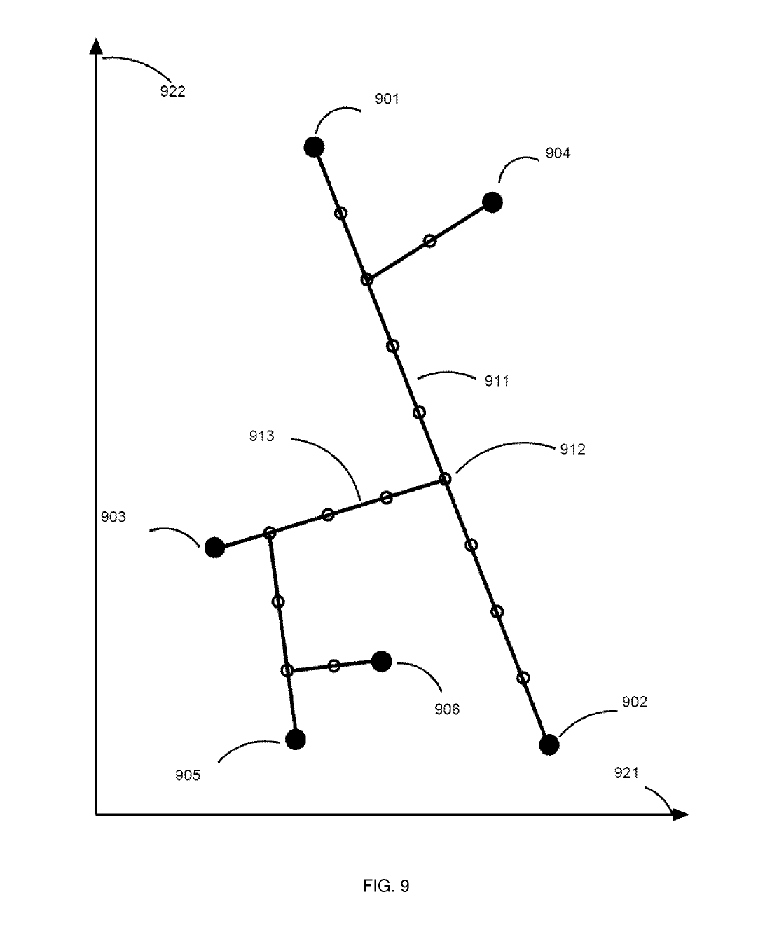

A two-dimensional example of the implementation of a rapidly exploring dense tree is shown in FIG. 9. The axes 921 and 922 span the range of two parameters. Points of the low-discrepancy sequence are given as 901, 902, 903, 904, 905 and 906. Starting at 901 the algorithm constructs a path 911 from 901 to 902 placing intermediate nodes such as 912 into the path so that the spacing between adjacent nodes on the path is less than the maximum step-size for the parameter. A path 913 is then made from the nearest node 912 on the previously defined graph to the next sample node 903. This construction sequentially connects sample nodes 904, 905 and 906. Perturbations are selected from a sequence of points defined by a congruent lattice (Sloan I. H. and Joe, S., Lattice Methods for Multiple Integration, Oxford Science Publications, Oxford University Press, 1994.

Modifications may be made to the present invention within the context of that described and shown in the drawings. Such modifications are intended to form part of the invention described in this specification.

1-40. (canceled)

41. A method of characterising a subsurface reservoir, said method comprising:
(i) receiving data representing a geological model of a reservoir, the reservoir model comprising a plurality of grid-cells, where the reservoir model is divided into the said grid-cells, and a location or locations of one or more boreholes within the reservoir being modelled;
(ii) receiving data representing a specification of reservoir parameters for generating geological realisations of the modelled reservoir;
(iii) calculating the volume and pressure of each fluid phase in each grid-cell from the reservoir parameters at a plurality of discrete time points, wherein each grid-cell has at least one property, wherein the time points are not uniform amongst all the grid-cells;
(iv) calculating the flux of each fluid phase between grid-cells and boreholes for each time point from the calculated volumes and pressures; and
(v) calculating borehole production for each borehole from the calculated fluxes.

42. A method according to claim 41, wherein the time step for each grid-cell is dependent on the identity of the grid-cell.

43. A method according to claim 41, wherein each grid-cell is not uniform in spatial dimension to all grid-cells in the reservoir model.

44. A method according to claim 41, wherein the pressure and volume calculations for each grid-cell and between grid-cells and well boreholes are calculated for each time point using a stable explicit scheme that does not require the simultaneous solution of a large matrix system of linear equations for all grid-cells.

45. A method according to claim 41, wherein the flux calculation uses a stable explicit method.

46. A method of characterising a subsurface reservoir, said method comprising:
(i) receiving data representing a geological model of a reservoir, the reservoir model comprising a plurality of grid-cells, where the reservoir model is divided into the said grid-cells, and a location or locations of one or more boreholes within the reservoir being modelled;
(ii) receiving data representing a specification reservoir parameters for generating geological realisations of the modelled reservoir;
(iii) calculating the volume and pressure of each fluid phase in each grid-cell from the reservoir parameters at a plurality of discrete time points, wherein the pressure and volume calculation for each grid-cell uses a stable explicit scheme that does not require the simultaneous solution of a large matrix system of linear equations for all grid-cells;
(iv) calculating the flux of each fluid phase between grid-cells and boreholes for each time point from the calculated volumes and pressures; and
(v) calculating borehole production for each borehole from the calculated fluxes.

47. A method of characterising a subsurface reservoir, said method comprising:
(i) receiving data representing a geological model of a reservoir, the reservoir model comprising a plurality of grid-cells, where the reservoir model is divided into the said grid-cells, and a location or locations of one or more boreholes within the reservoir being modelled;
(ii) receiving data representing a specification reservoir parameters for generating geological realisations of the modelled reservoir;
(iii) calculating the volume and pressure of each fluid phase in each grid-cell from the reservoir parameters at a plurality of discrete time points;
(iv) calculating the flux of each fluid phase between grid-cells and boreholes for each time point from the calculated volumes and pressures, wherein the fluid flux for each fluid phase of each grid cell uses a stable explicit method; and
(v) calculating borehole production for each borehole from the calculated fluxes.

48. A method according to claim 44, wherein a mass balance for a plurality of grid cells at a time point in the stable explicit method includes a function of the previous potential of a phase.

49. A method according to claim 44, wherein a mass balance for a plurality of grid cells at a time-point in the stable explicit method includes a product of an interpolation factor and a potential of a phase.

50. A method according to claim 44, wherein a mass balance for a plurality of grid cells at a time point in the stable explicit method is calculated from the three phase flux across a single face of the cell.

51. A method according to claim 44, wherein a mass balance for a plurality of grid cells at a time point in the stable explicit method is calculated simultaneously from the three phase flux across a plurality of faces of the cell.

52. A method according to claim 44, wherein a mass balance for a plurality of grid cells at a time point in the stable explicit method includes a function of the previous flux across a single face of the cell.

53. A method according to claim 44, wherein a mass balance for a plurality of grid cells at a time point in the stable explicit method includes a function of the previous flux across a plurality of faces of the cell.

54. A method according to claim 41, wherein the method further comprises:
(vi) checking whether a termination condition is met;
(vii) calculating a perturbation of each of the reservoir parameters and repeating steps (iii) to (vii) when the termination condition is not met; and
(viii) outputting the calculated production for each borehole.

55. A method according to claim 54, wherein the perturbations are calculated with an incremental perturbation point sampling technique.

56. A method according to claim 55, wherein the point sampling technique comprises a random point sequence.

57. A method according to claim 55, wherein the point sampling technique comprises a quasi-random point sequence.

58. A method according to claim 54, wherein the perturbations are generated as trajectories or sequences of steps for each parameter.

59. A method according to claim 58, wherein the trajectory sampling technique comprises a Lissajous curve technique.

60. A method according to claim 58, wherein the trajectory sampling technique comprises a saw-tooth curve technique.

61. A method according to claim 54, wherein the parameter perturbations are calculated with an incremental perturbation path sampling technique.

62. A method according to claim 61, wherein the path sampling technique comprises a rapidly exploring dense tree technique.

63. A method according to claim 61, wherein the path sampling technique comprises a minimum spanning tree technique.

64. A method according to claim 61, wherein the path sampling technique comprises a random line segment technique.

65. A method according to claim 61, wherein the path sampling technique comprises a congruent lattice sampling technique.

66. A method according to claim 54, wherein the method further comprises receiving data representing historical fluid production and pressure data from each borehole and calculating a mismatch between historical and calculated fluid production and between historical and calculated pressure, before step (vi); wherein the calculated mismatch is used in step (vii) to calculate the perturbation of the of reservoir parameters.

67. A method according to claim 66, wherein the mismatch is calculated as the sum of the weighted differences between historical production and measured production for each fluid and between historical and measured pressure at a sequence of time points.

68. A method according to claim 66, wherein the mismatch is calculated as the sum of the weighted differences between historical fractional flow and calculated fraction flow at a sequence of time points.

69. A method according to claim 66, wherein the mismatch is calculated between historical and calculated seismic data.

70. A computing apparatus comprising:
(i) an input for receiving data representing a geological model of a reservoir, the reservoir model comprising a plurality of grid-cells, where the reservoir model is divided into the said grid-cells, and a location or locations of one or more boreholes within the reservoir being modelled;
(ii) an input for receiving data representing a specification of perturbations of reservoir parameters for generating geological realisations of the modelled reservoir;
(iii) a calculation module for calculating the volume and pressure of each fluid phase in each grid-cell from the reservoir parameters at a plurality of discrete time points, wherein each grid-cell has at least one property, wherein the time points are not uniform amongst all the grid-cells;
(iv) a calculation module for calculating the flux of each fluid phase between grid-cells and boreholes for each time point from the calculated volumes and pressures; and
(v) a calculation module for calculating borehole production for each borehole from the calculated fluxes.
